(19) United States
(12) Patent Application Publication
(10) Pub. No.: US 2009/0273569 A1
(43) Pub. Date: Nov. 5, 2009

(54) MULTIPLE TOUCH INPUT SIMULATION USING SINGLE INPUT PERIPHERALS

(75) Inventors: Bodgan Popp, Sammamish, WA (US); Debora Everett, Sultan, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/113,934

(22) Filed: May 1, 2008

(51) Int. Cl. G06F 3/041

(52) U.S. Cl. 345/173

(57) ABSTRACT

A multiple touch input simulation for a virtual interactive display system using single input peripherals is disclosed. For example, one disclosed embodiment comprises a method for simulating a multiple touch input for a virtual interactive display system that receives a first input from a first input device, receives a second input from a second input device, associates the first input with a first data object and the second input with a second a data object to simulate a multiple touch input, and provides the data object to a multiple touch client application.

### BACKGROUND

Personal computers use serial input systems that receive a single input from a keyboard or a mouse. Several serial input peripherals may be coupled to a computer, but the computer will still receive a single input at any given time. As an example, when multiple mice are coupled to a computer, a single cursor is displayed and the cursor position will be updated based on the last mouse movement.

Recently, interactive multiple touch input display systems, sometimes called touch-sensitive devices, and corresponding multiple touch input applications, have become more available. Touch-sensitive devices operate by detecting touch-based inputs via any of several different mechanisms, including but not limited to optical, resistive, acoustic, and capacitive mechanisms. Some optical touch-sensitive devices detect touch by capturing an image of a backside of a touch screen via an image sensor, and then processing the image to detect objects located on the screen. However, due to the relatively high cost of multiple input interactive display systems, multiple input application development has been limited. Further, personal computers have not readily been available for multiple input application development due to their serial input systems.

### SUMMARY

Accordingly, various embodiments for a multiple input simulation for a virtual interactive display system using single input peripherals are described below in the Detailed Description. For example, one embodiment comprises receiving multiple inputs from a multiple input devices, associating one or more the inputs with one or more data objects to simulate a multiple touch input, and providing the one or more data objects to a multiple touch client application. In one example application, a simulated multiple input for a virtual interactive display system can be used to aid application development and testing without requiring a separate multiple touch input device.

This Summary is provided to introduce concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of an optical touch-sensitive device.

FIG. 2 shows an example of an embodiment device to simulate a multiple touch input for a virtual interactive display system.

FIG. 3 illustrates an embodiment simulator graphical user interface for a virtual interactive display system.

FIG. 4 shows a process flow depicting an embodiment of a method for a multiple input simulation for a virtual interactive display system using single input peripherals.

### DETAILED DESCRIPTION

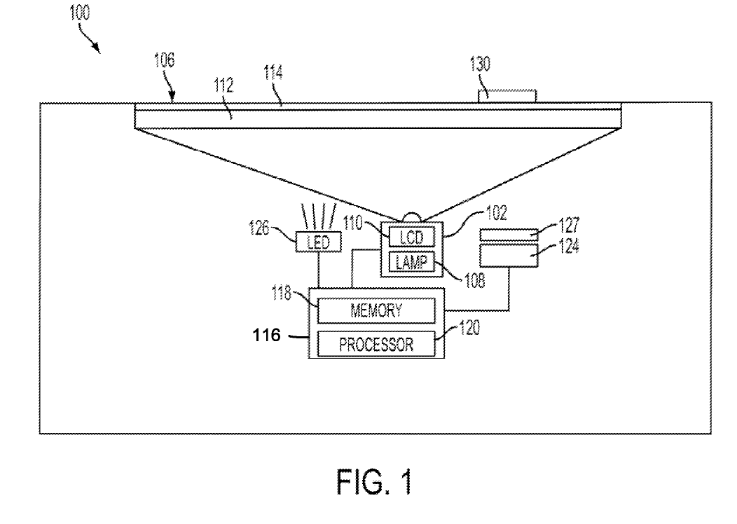

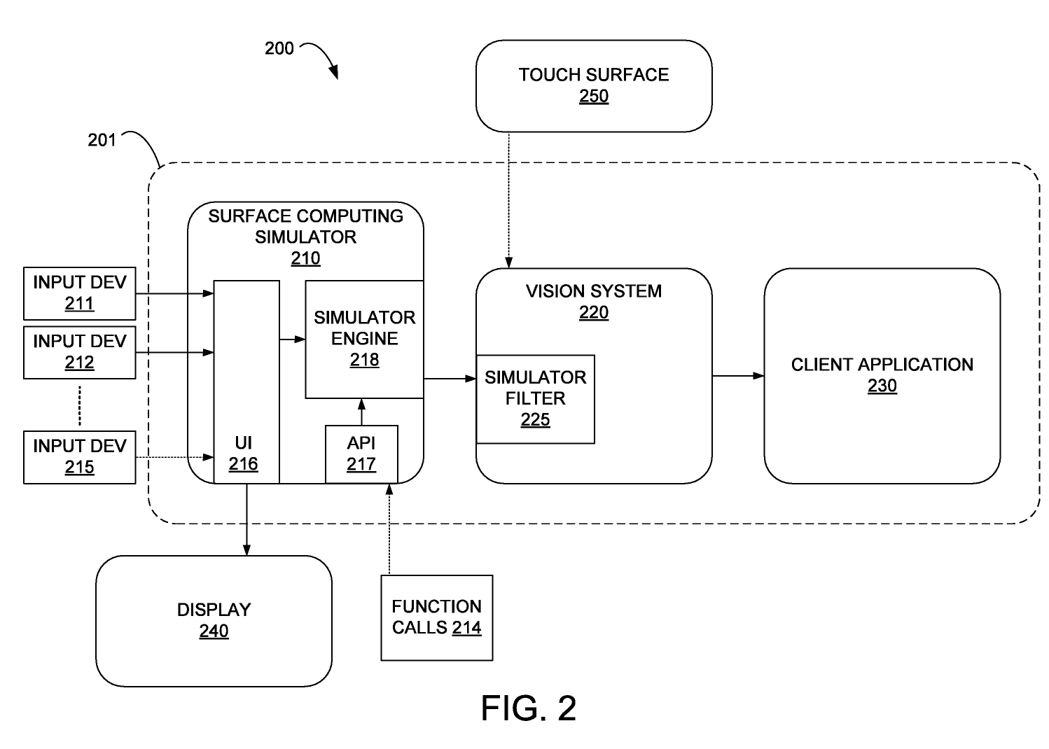

Prior to discussing multiple input simulations for a virtual interactive display system, a interactive display device 100 is described. While embodiments herein are not limited to the interactive display device 100, the principle of operation of the interactive display device 100 will provide a foundation to describe the embodiments described below with reference to FIGS. 2-4. FIG. 1 shows a schematic depiction of an optical touch-sensitive device in the form of an interactive display device 100. The interactive display device 100 comprises a projection display system having an image source 102, and a display screen 106 onto which images are projected. In this example, the image source 102 includes a light source 108 such as a lamp (depicted), an LED array, or other suitable light source. The image source 102 also includes an image-producing element 110 such as the depicted LCD (liquid crystal display), an LCOS (liquid crystal on silicon) display, a DLP (digital light processing) display, or any other suitable image-producing element. The display screen 106 includes a clear, transparent portion 112, such as sheet of glass, and a diffuser screen layer 114 disposed on top of the clear, transparent portion 112. As depicted, a diffuser screen layer 114 acts as a touch surface.

The image sensor 124 may be configured to detect light of any suitable wavelength, including but not limited to infrared and visible wavelengths. To assist in detecting objects placed on display screen 106, the image sensor 124 may further include an illuminant, such as LED(s) 126, configured to produce infrared or visible light to illuminate a backside of display screen 106. Light from LED(s) 126 may be reflected by objects placed on display screen 106 and then detected by image sensor 124. The use of infrared LEDs as opposed to visible LEDs may help to avoid washing out the appearance of images projected on display screen 106. Further, a bandpass filter 127 may be utilized to pass light of the frequency emitted by the LED(s) 126 but prevent light at frequencies outside of the bandpass frequencies from reaching the image sensor 124, thereby reducing the amount of ambient light that reaches the image sensor 124.

The interactive display device 100 further includes a controller 116 comprising memory 118 and a processor 120 configured to conduct one or more multiple touch input operations. It will further be understood that memory 118 may comprise instructions stored thereon that are executable by the processor 120 to control the various parts of interactive display device 100 to effect the methods and processes described herein.

FIG. 1 also depicts an object 130 placed on display screen 106. Object 130 represents any object that may be in contact with display screen 106, including but not limited to a finger, stylus, or other manipulator. Additionally, object 130 may represent a mouse cursor displayed on display screen 106. To sense objects placed on display screen 106, the interactive display device 100 includes an image sensor 124 configured to capture an image of the entire backside of display screen 106, and to provide the image to controller 116 for the detection of objects appearing in the image. The interactive display device 100 may detect and track multiple temporally overlapping touches from any suitable number of manipulators (i.e. potentially as many manipulator or object touches as can fit on the display screen 106 at a time), may be configured to detect and distinguish the touch of many different types of manipulators and objects. Additionally, the interactive display device 100 may be configured to detect and distinguish multiple touch inputs comprising groups of touches, wherein each group is intended as a single input. However, due to the relatively high cost of an interactive display device 100, development for multiple input applications has been limited. In some embodiments, a computing device may be altered from a single input peripheral computing device to one that accepts multiple inputs. In this way, one or more multiple touch input applications can be simulated on a computing device, as illustrated in the following paragraphs with reference to FIGS. 2-4.

FIG. 2 shows an example embodiment system 200 to simulate a multiple touch input for a virtual interactive display system. The illustrated embodiment system 200 includes input device 211 and input device 212 coupled with computing device 201. Example input devices include a computer mouse, keyboard, scroll input device, ball input, or other suitable input devices. Other multiple inputs may be received from function calls 214 exposed through API 217, as examples. The computing device 201 is coupled with display 240, and may further be coupled with an interactive display device such as a touch surface 250. In some embodiments computing device 201 may have additional inputs, including input device 215, function calls 214, as non-limiting examples.

In the embodiment illustrated in FIG. 2, computing device 201 includes a surface computing simulator 210, a vision system 220, and a client application 230. Surface computing simulator 210 may include a user interface, depicted as UI 216, wherein UI 216 is coupled with input devices and with display 240. For example, UI 216 may have multiple ports, wherein surface computing simulator 210 may be configured to receive a first input from the first input device through the first port, a second input from the second input a first port through a second port, and a third port to receive a third input from a keyboard, as non-limiting examples.

Computing device 201 may further have a controller in communication with the first port and second port, wherein the controller includes a processor and a memory (not shown) containing computer-readable instructions executable to run the surface computing simulator 210, vision system 220, and client application 230. In the embodiment illustrated in FIG. 2, surface computing simulator 210 may receive inputs from either UI 216, through API 217, etc. and processes these inputs in a surface computing simulator engine 218. In one example, computing device 201 may be a personal computer, where input device 211 and input device 212 may each be a computer mouse. In this way, the surface computing simulator 210 may associate the first input with a first data object and the second input with a second data object to simulate a multiple touch input. In some embodiments, surface computing simulator 210 may provide the first data object and the second data object to multiple touch client application 230 to simulate a multiple touch input to the client application 230 using serial input devices.

In more detail, surface computing simulator 210 may receive a first input from a first mouse that comprises location or tracking information. While the first input is being received, surface computing simulator 210 may receive a second input from a second mouse comprising location or tracking information. UI 216 provides for the reception of these input signals and forwards the signals to simulator engine 218. Simulator engine 218 then coordinates the location and tracking information with various objects from a collection of contact objects stored in memory that represent corresponding touch inputs. For example, simulator engine 218 may associate a contact object representing a first finger touch with a first mouse input and a second contact object representing a second mouse input, wherein the mouse inputs are then stored as finger touches in a shared memory. Other embodiments are not so limited, and multiple touch inputs may be generated from mouse inputs, or from touch inputs such as from a finger, stylus, or other suitable manipulator.

Simulator engine 218 may send addressing information of the finger touches stored in shared memory to the simulator filter 225 to allow the vision system 220 to process the inputs and batch them together as simulated multiple touch inputs. In this way, simulator filter 225 may convert user input received from the surface computing simulator 210 into object data to be provided to a client application 230, for example through an API or a set of APIs exposed through a software development kit.

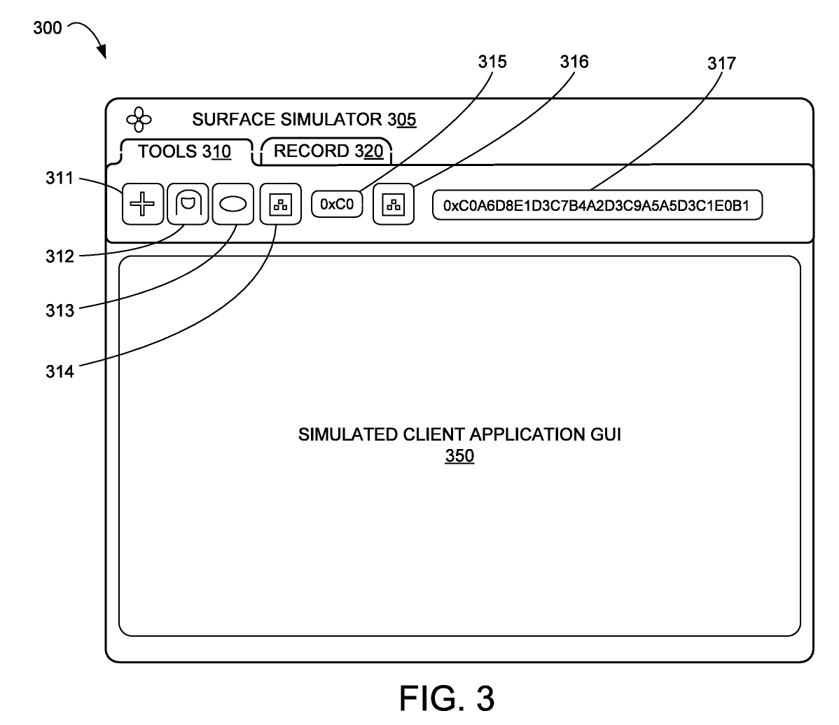

In other embodiments, the corresponding touch inputs may be sent to simulator filter 225 using an inter-service protocol, extensible filters, and other suitable communications. Simulator filter 225 may then provide vision system 220 with the same format of contact objects (touch objects) as would be received from touch surface 250, including a finger input, a general object (blob input), a tagged object, etc. In this way, a client application 230 may be run in a simulated computing environment substantially similar to the environment it will eventually be run in. Some embodiments may provide a simulator window to allow user assigning of data objects as a finger input, a blob input, or a tagged object using a control panel in a simulator window, as explained in more detail below with reference to FIG. 3. Furthermore, a sequence of inputs may be recorded with a touch surface 250, and played back to a multiple input application running in a simulated environment on a personal computer, as a non-limiting example.

In some embodiments, when multiple inputs may be coupled with computing device 201, computing device 201 may further be configured to run a plurality of multiple touch client applications, wherein a first group of multiple touch inputs may correspond to a first application and a second group of multiple touch inputs correspond to a second application, as a non-limiting example.

In some embodiments, computing device 201 may be configured to receive multiple inputs and provide a sequence of data objects to a multiple touch client application. Additionally, computing device 201 may be configured to record the sequence of data objects in a script to be stored and played back to a multiple touch client application. In some embodiments, computing device 201 may have a display including a simulator window to display a multiple touch client application running in response to the sequence of data objects.

In some embodiments the computing device 201 may also be to simulate at least one of an erroneous code designating a tagged object or latency in a virtual interactive display system, or other real time simulations. For example, simulator engine 218 may provide a misreading of an input object, processing or throughput delays related to bandwidth limitations, etc., to simulate a runtime environment to a client application 230. Generally, a computing device so configured can simulate a runtime environment more closely by also not requiring extra code to be compiled in a client application, not altering which application has the foreground on a graphical user interface, simulate a vision system running at full frame rate, etc.

FIG. 3 illustrates an embodiment simulator window 300 including a graphical user interface for surface simulator 305 for a virtual interactive display system. For example, some embodiments may provide a simulator window 300 including a control panel including tools 310 to allow user assigning of data objects as a finger input 312, a general object (blob input) 313, a tagged object such as a low-resolution tag 314 represented by low-resolution tag code 315, a high-resolution tag 316 represented by corresponding high-resolution tag code 317, etc., using a selector 311 to select an object to be assigned. Further, in the depicted embodiment, a user may record inputs using the record 320 tab, wherein one or more inputs may be recorded and later played back to a multiple touch client application. Further, a simulated client application GUI 350 may be displayed in simulator window 300 to graphically represent simulated multiple touch inputs being run on a client application.

In some embodiments, cursor behavior may be adjusted between multiple touch inputs and serial devices inputs while transitioning between the simulated client application GUI 350 and the control panel including the tools 310 and record 320 tabs, or even to and from a surrounding windows environment. For example, while multiple mouse inputs may be allowed to represent multiple touch inputs within the simulated client application GUI 350, an embodiment may allow only one mouse cursor to operate outside the simulated client application GUI 350.

In some embodiments, a control panel may provide the ability to transform a sheer location based system such as a mouse input, with a left, right, up, and down, into a system with no orientation. Additionally, extra dimensions may be simulated with mouse inputs. For example, a 2.5 dimensional system may be represented, such as in computer aided manufacturing, where each cursor can be represented either on the surface or above the surface, as an example.

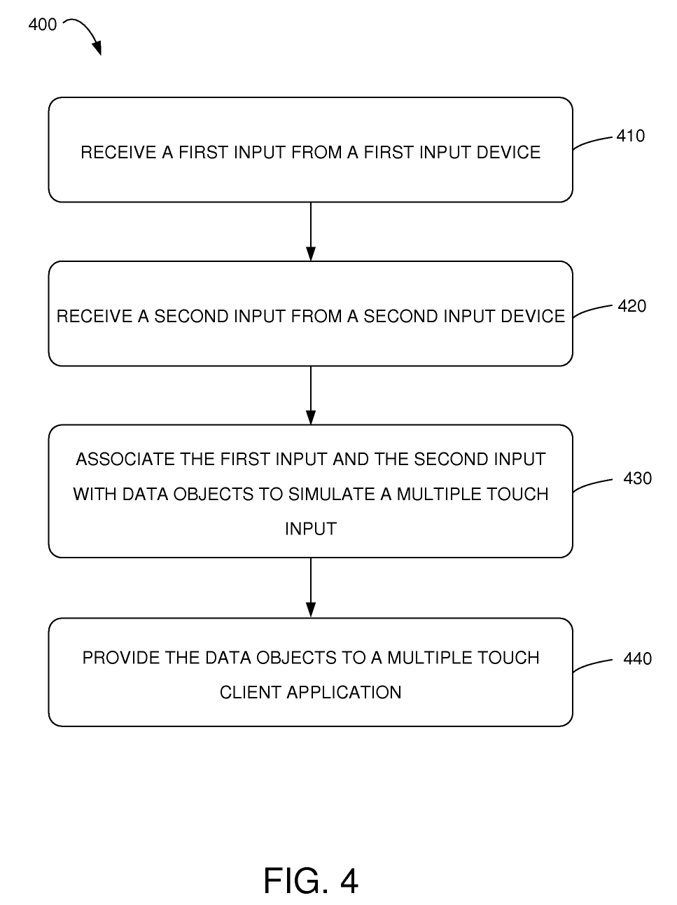

Continuing with the figures, FIG. 4 shows a process flow depicting an embodiment of a method 400 for a multiple input simulation of a virtual interactive display system using single input peripherals. First, as indicated in block 410, method 400 comprises receiving a first input from a first input device. This may comprise receiving a first input from a mouse, a keyboard, a track ball, any serial input device, or other suitable input devices.

Method 400 also comprises receiving a second input from a second input device as indicated in block 420. Similar to block 410, this may comprise receiving a first input from a mouse, a keyboard, a track ball, any serial input device, or other suitable input devices. Additionally, the second input device may be a different device as the first input device in block 410.

Next, method 400 comprises associating the first input with a first data object and associating the second input with a second data object to simulate a multiple touch input, as indicated at block 430. Then, in block 440 the method comprises providing the data object to a multiple touch client application. In some embodiments, the first or the second data object may represent at least one of a finger input, a general object (blob input), a tagged object, etc. In some embodiments, method 400 may further comprise assigning a data object a finger input, a general object (blob input), a tagged object, etc. using a control panel in a simulator window.

In some embodiments, method 400 may further comprise providing a sequence of data objects to the multiple touch client application in response to multiple received inputs, and simulating the multiple touch client application using the sequence of data objects to represent a plurality of multiple touch inputs, wherein simulating the multiple touch client application includes displaying the multiple touch client application on a non-multiple touch display. Additionally, some embodiments may further comprise recording the sequence of data objects in a script that can be stored and played back to a multiple touch client application.

Some embodiments may simulate a multiple touch client application by displaying a sequence of data objects and the multiple touch client application in a simulator window, by simulating an erroneous code designating a tagged object in a virtual interactive display system, by simulating latency in a virtual interactive display system. For example, a multiple touch input device may read tagged objects and already have a data object or functionality associated with the tagged object. Therefore, an embodiment may represent not only a tagged object as a data object, it may also represent a misread of the tagged object, such as an erroneous code read from a tagged object. In this way an application under development can be tested to see how it responds to an incorrectly read tagged object. Additionally, an embodiment method may further comprise running a plurality of multiple touch client applications in a virtual interactive display system.

It will be appreciated that the embodiments described herein may be implemented, for example, via computer-executable instructions or code, such as programs, stored on a computer-readable storage medium and executed by a computing device. Generally, programs include routines, objects, components, data structures, and the like that perform particular tasks or implement particular abstract data types. As used herein, the term “program” may connote a single program or multiple programs acting in concert, and may be used to denote applications, services, or any other type or class of program. Likewise, the terms “computer” and “computing device” as used herein include any device that electronically executes one or more programs, including, but not limited to, surface computing devices, personal computers, servers, laptop computers, hand-held devices, microprocessor-based programmable consumer electronics and/or appliances, PDAs, etc.

While disclosed herein in the context of simulating multiple inputs of a virtual interactive display system using single input peripherals, it will be appreciated that the disclosed embodiments may also be used in any other suitable touch-sensitive device. It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description. The subject matter of the present disclosure includes all novel and nonobvious combinations and subcombinations of the various processes, systems and configurations, and other features, functions, acts, and/or properties disclosed herein, as well as any and all equivalents thereof.

1. A computing device to simulate a multiple touch input for a virtual interactive display system, the computing device comprising:
a first port coupled with a first input device;
a second port coupled with a second input device; and
a controller in communication with the first port and second port, the controller comprising a processor and memory containing computer-readable instructions executable to:
receive a first input from the first input device and a second input from the second input device;
associate the first input with a first data object and the second input with a second data object; and
provide the first data object and the second data object to a multiple touch client application to simulate a multiple touch input.

2. The computing device of claim 1, wherein the first data object or the second data object represent at least one of a finger input, a general object, or a tagged object.

3. The computing device of claim 1, wherein the controller is configured to receive multiple inputs and provide a sequence of data objects to the multiple touch client application.

4. The computing device of claim 3, wherein the controller is configured to record the sequence of data objects in a script to be stored and played back to a multiple touch client application.

5. The computing device of claim 3 comprising a display, the display including a simulator window to display the multiple touch client application running in response to the sequence of data objects.

6. The computing device of claim 3, wherein the controller is configured to simulate at least one of an erroneous code designating a tagged object or a latency in a virtual interactive display system.

7. The computing device of claim 1, further comprising a third port to receive a third input from a keyboard, wherein the controller is configured to create a data object representing a multiple touch input using the third input.

8. The computing device of claim 1, wherein the controller is configured to run a plurality of multiple touch client applications.

9. The computing device of claim 1, wherein the controller is configured to assign a data object as a finger input, a general object, or a tagged object using a control panel in a simulator window.

10. A method of simulating a multiple touch input for a virtual interactive display system, the method comprising:
receiving a first input from a first input device;
receiving a second input from a second input device;
associating the first input with a first data object;
associating the second input with a second data object; and
providing the first data object and the second data object to a multiple touch client application.

11. The method of claim 10, wherein the first data object or the second data object represents at least one of a finger input, a general object, or a tagged object.

12. The method of claim 11, further comprising assigning a data object as a finger input, a general object, or a tagged object using a control panel in a simulator window.

13. The method of claim 10, further comprising:
providing a sequence of data objects to the multiple touch client application in response to multiple received inputs; and
simulating the multiple touch client application using the sequence of data objects to represent a plurality of multiple touch inputs, wherein simulating the multiple touch client application includes displaying the multiple touch client application on a non-multiple touch display.

14. The method of claim 13, further comprising recording the sequence of data objects in a script, wherein the script can be stored and played back to a multiple touch client application.

15. The method of claim 13, wherein simulating the multiple touch client application further comprises displaying the sequence of data objects and the multiple touch client application in a simulator window.

16. The method of claim 13, further comprising simulating an erroneous code designating a tagged object in a virtual interactive display system.

17. The method of claim 13, further comprising simulating latency in a virtual interactive display system.

18. The method of claim 13, further comprising running a plurality of multiple touch client applications in a virtual interactive display system.

19. The method of claim 10, wherein the first input device is a first computer mouse and the second input device is a second computer mouse.

20. A computer-readable medium comprising instructions executable by a computing device to simulate a multiple touch input for a virtual interactive display system, the instructions being executable to perform a method comprising:
receiving a first input from a first input device;
receiving a second input from a second input device;
associating the first input with a first data object;
associating the second input with a second data object; and
providing the first data object and the second data object to a multiple touch client application to simulate a multiple touch input.
